(19) United States
(12) Patent Application Publication
(10) Pub. No.: US 2025/0033375 A1
(43) Pub. Date: Jan. 30, 2025

(54) Method for Determining a Colour Deviation of at Least One Print Decoration Applied to a Carrier Material From a Print Template

(71) Applicant: Flooring Technologies Ltd., Kalkara (MT)

(72) Inventors: Norbert Kalwa, Horn-Bad Meinberg (DE); Jinming Zhang, Berlin (DE)

(21) Appl. No.: 18/707,982

(22) PCT Filed: Nov. 3, 2022
(86) PCT No.: PCT/EP2022/080724

§ 371 Date: May 7, 2024

(30) Foreign Application Priority Data
Nov. 8, 2021 (EP) 21206894.4

(51) Int. Cl. B41J 2/21; B41M 3/06

(52) U.S. Cl. CPC B41J 2/211; B41M 3/06

(57) ABSTRACT

Provided is a method for determining the colour deviation of at least one print decoration applied to at least one carrier material from a print template using only NIR spectroscopy including the steps of recording of at least one NIR spectrum of several reference samples with the print template using at least one NIR measuring head in a wavelength range between 700 nm and 2500 nm, applying the at least one printed decoration to the at least one carrier material by means of printing, recording at least one NIR spectrum of the carrier material printed with the print decoration using the at least one NIR measuring head in a wavelength range between 700 nm and 2500 nm, and determining the colour deviation of the print decor by comparing with the at least one NIR spectrum recorded for the print template.

### CROSS-REFERENCE TO RELATED APPLICATIONS

This application is the United States national phase of International Patent Application No. PCT/EP2022/080724, filed Nov. 3, 2022, and claims priority to European Patent Application No. 21206894.4, filed Nov. 8, 2021, the disclosures of which are hereby incorporated by reference in their entireties.

### BACKGROUND

### 1. Technical Field

The present disclosure relates to a method for determining a colour deviation or colour change of at least one print decoration, which is applied to at least one carrier material, from a print template or master decor or master template.

### 2. Technical Considerations

Substrates with a décor, such as wood-based panels or paper layers, are mainly printed using gravure or digital printing processes.

Gravure printing is a printing technique in which the elements to be imaged are present as depressions in a printing forme that is inked before printing. The printing ink is mainly located in the depressions and is transferred to the object to be printed, such as a substrate, due to the contact pressure of the printing forme and adhesion forces.

In digital printing, on the other hand, the printed image is transferred directly from a computer to a printing machine such as a laser printer or inkjet printer. This eliminates the use of a static printing plate.

Digital printing is increasingly being used as part of the technical development of printing technology on a wide range of substrates. While digital printing processes were initially used primarily in the graphic arts industry such as advertising agencies, advertising material manufacturers or printers, it is now becoming apparent that digital printing processes are also being used more frequently in other branches of industry. There are many reasons for this, but two main arguments can be identified. Digital printing enables the production of a print image with a particularly high quality due to a higher resolution and also allows a wider range of applications with a high degree of flexibility. This is illustrated by the fact that the printed image is no longer limited in terms of length.

When printing decors, a major problem is the occurrence of colour deviations. This is true regardless of the printing processes and also regardless of the industries.

Today, fast printing processes are used almost everywhere, in which large quantities of printed surfaces/products are produced in a very short time and thus the damage in case of colour deviations can be considerable. Modern printing machines run—depending on the industry—at up to several hundred metres per minute.

This is especially true for printing on paper, as paper is made from a renewable raw material, which means that fluctuations in properties are more pronounced than with other substrates. In addition, the substrate paper is relatively thin in most cases during printing, which makes properties that depend on the thickness (air permeability, smoothness, etc.) more relevant to quality. Another problem is that paper is very rarely printed with uni colours. These are significantly more favourable than wood reproductions, stone decors or fancy decors with regard to the assessment of colour consistency.

The method usually used to check colour uniformity is to view the current production in comparison to a master template or a print template under standardised conditions (lighting conditions, viewing distance and angle). However, this requires production to be stopped, a representative sample to be taken and production to be restarted after inspection. This takes time and increases costs. Moreover, this procedure does not allow continuous monitoring, which is desirable in a modern production process.

Recently, scanners have been used to solve this problem by constantly comparing the current print with an agreed master pattern. However, this procedure is technically very complex.

This results in the following disadvantages: complex system; high costs; production losses due to quality inspection.

### SUMMARY

The disclosure is therefore based on the technical object of making colour deviations detectable with a simple measuring system. This should not make high demands on the requirements for measurement. In addition, it should be suitable for both in-line/on-line and off-line measurement. Because of the high production speeds on the presses, the system should generate measured values quickly, if possible several measured values per second. The measured values generated should also enable a quick assessment.

This object is solved by a method with features as described herein.

### BRIEF DESCRIPTION OF THE DRAWINGS

The disclosure is explained in more detail below with reference to the figures in the drawings using an example of non-limiting embodiments.

FIG. 1 shows a first NIR spectrum for determining the colour deviation according to a first non-limiting embodiment; and

FIG. 2 shows a second NIR spectrum for determining the colour deviation according to a second non-limiting embodiment.

### DETAILED DESCRIPTION

Provided is a method is provided for determining the colour deviation or colour changes of at least one print decoration from a print template or master template, wherein the at least one print decoration is applied to at least one carrier material. In non-limiting embodiments, the present method includes:
Recording of at least one NIR spectrum of several reference samples with the print template using at least one NIR measuring head in a wavelength range between 700 nm and 2500 nm, preferably between 900 nm and 1800 nm, in particular preferably between 1200 nm and 1700 nm,
Applying the at least one printed decoration to the at least one carrier material by means of printing,
Recording at least one NIR spectrum of the carrier material printed with the print decoration using the at least one NIR measuring head in a wavelength range between 700 nm and 2500 nm, preferably between 900 nm and 1800 nm, in particular preferably between 1200 nm and 1700 nm, and
Determining the colour deviation of the print decor by comparing with the at least one NIR spectrum recorded for the print template

A quantification results from the distance between the two or more lines of the spectrum. The colour differences (distances between the spectra) depend, among other things, on the type of decoration (light, medium-light, dark). Since no calibration is carried out, an assessment is first necessary for each print in the current production. This means that the colour difference between the current print and the master template must also be assessed visually. From this assessment over several productions, a limit can then be determined, in particular using suitable software. As long as the print remains within the limit(s) determined in this way, production can continue. If the pressure is outside the limit, the production must be readjusted.

Accordingly, a separate assessment is necessary for each decor. The distances between the spectra depend strongly on the decor. The measurements also showed, for example, that the spectrum of a very strong colour deviation lay between the spectrum of the master template and the spectrum of a small colour deviation.

Another significant advantage of the present method is that the measurement in the NIR range is sufficient and no other wavelength ranges, such as in the visible range (e.g. between 400 and 700 nm), are necessary for determining the color deviation. The present method is therefore based exclusively on the recording of an NIR spectrum; spectra in the visible range, on the other hand, are not recorded.

Accordingly, the use of only at least one NIR measuring head is sufficient; further sensors, such as sensors for visible light, are not necessary. This simplifies the design of the measuring system.

As can be seen in the figures of the non-limiting embodiments, the colour deviation can result in a parallel shift of the measured NIR spectrum. In the case of a parallel shift of the measured NIR spectrum, the NIR measurement of the reference samples and the samples can be measured also at limited wavelength ranges between 700 nm and 2000 nm, preferably between 900 nm and 1800 nm, in particular preferably between 1200 and 1700 nm and even more preferably between 1350 nm and 1600 nm.

However, it may also be the case that the colour deviation does not lead to a parallel shift of the measured NIR spectrum, but rather that deviations occur in other areas of the NIR spectrum in each case. Thus, the colour deviations in samples to be measured from the master template can be recognised by means of absorption peaks in different wavelength ranges; e.g. absorption peaks for the sample to be measured in a wavelength range between 1100-1200 nm and for the master template in a wavelength range between 1400-1600 nm.

According to the present method, an NIR spectrum for a decor is generated using an NIR measuring head. In the process, the NIR radiation excites the organic colour molecules, which are usually used in indirect gravure and digital printing, to vibrate. This energy-consuming process can then be detected in the form of a spectrum. Since this measuring method generates a large number of spectra relatively quickly, deviations from the desired quality (master sample) can be detected quickly. Only a simple comparison of the current spectrum with the stored master pattern spectrum is carried out.

Unexpectedly, it has been shown that even minor colour deviations are recognisable with this method. Even colour deviations that are still judged acceptable by the observer in relation to the master pattern are clearly distinguishable in the NIR spectrum. There is a clear tendency from very light to very dark decors, i.e. the distances between the spectra are clearer for dark decors than for light decors. By defining maximum distances between the spectra, an intervention point can be defined from which colour correction measures are initiated. A trend can also be made visible through visualisation over time.

The method can be used to record individual spectra of a defined decorative section or an average spectrum over the running web. In this way, both an off-line and an in-line inspection can be realised. For this purpose, either a sample is taken and examined off-line or the NIR measuring head is positioned on the printed paper at a defined distance from the edge. By evaluating the spectrum, it is also possible to determine which colour of the colour set (e.g. CMYK in digital printing) needs to be readjusted in comparison to the master sample. This can be automatically readjusted via software.

Instead of NIR spectroscopy, IR spectroscopy can also be used for these measurements.

The present method offers several advantages. A simple measuring procedure with a very sensitive measuring method is provided. The method can be used off-line and on-line or in-line and is also easy to install. In particular, the determination of the colour deviation can be carried out continuously and online.

The present method enables the provision of the measured values in a short time (online, preferably without disturbing time delay) compared to conventional (known) measuring methods. The measurement data can be used for quality assurance, research and development, process control, regulation, control, etc. The measurement process does not reduce the production speed, etc. Basically, it improves the monitoring of production. In addition, downtimes due to quality determinations and plant adjustments are also reduced.

First of all, reference samples of carrier material provided with a print template as the initial design or master template are provided. It is essential that the reference sample is similar to the sample to be measured, especially with regard to the carrier material and its degree of processing. The similarity of the sample to be measured and the reference sample is particularly important when using resinous carrier materials, such as e.g. pre-impregnated paper layers.

As explained above, at least one NIR spectrum is recorded from these reference samples in a wavelength range between 500 nm and 2500 nm; i.e. the entire wavelength range of the NIR spectrum is taken as a basis. Depending on the samples to be measured and the occurring deviations of the NIR spectra, an NIR spectrum can also be recorded in a limited wavelength range between 700 nm and 2000 nm, preferably between 900 nm and 1700 nm, and particularly advantageously between 1350 nm and 1600 nm. For example, for the measurement of the grey ash wood decor, an NIR spectrum is recorded in a wavelength range from 950 to 1650 nm.

Subsequently, at least one print decoration is applied to the at least one carrier material by means of printing, in particular gravure or digital printing, and at least one NIR spectrum of the carrier material printed with the print decoration is recorded.

The desired parameter of the printed carrier material (here the colour deviation from the master template or initial decor) can then be determined by comparing the NIR spectrum recorded for the printed carrier material with the reference sample.

It is thus possible to determine the colour deviation from a single NIR spectrum determined for the sample to be measured by an automated comparison or matching with the NIR spectra determined for the respective reference sample.

It makes sense to compare and interpret the NIR spectra and determine the colour deviation over the entire recorded spectral range.

In non-limiting embodiments of the present method, the at least one carrier material comprises at least one paper layer, in particular at least one base paper or at least one pre-treated, impregnated paper.

In non-limiting embodiments of the present method, the at least one support material comprises a board made of a wood-based material, in particular a particleboard, medium-density fibreboard (MDF), high-density fibreboard (HDF), oriented strand board (OSB) or plywood board, made of plastic, a wood-based material-plastic mixture or a composite material, a cement fibreboard, gypsum fibreboard or a WPC board (wood plastic composites) or an SPC board (stone plastic composites).

As mentioned above, the printed decoration is preferably applied to the at least one carrier material using gravure printing processes or digital printing processes.

These printing processes, especially digital printing, are nowadays almost exclusively carried out using the CMYK colour system. The CMYK colour model is a subtractive colour model, whereby the abbreviation CMYK stands for the three colour components cyan, magenta, yellow (yellow) and the black component key as colour depth. With this colour system, a colour space (gamut) can be reproduced that meets many requirements from a wide range of areas.

Nevertheless, the CMYK colour space is a compromise that leads to the fact that certain colours either cannot be produced at all or the use of additional colours is necessary. This problem arises particularly in the reproduction of wood decors in the furniture or laminate flooring industry, where different shades of brown have to be produced.

In non-limiting embodiments, an ink having a modified pigment composition is used. Accordingly, the ink used for printing is a water-soluble CRYK ink having the following composition:
Colour component C: at least one cyan pigment;
Colour component K: at least one black carbon pigment;
Colour component Y: at least one yellow pigment; or a mixture of at least two different yellow pigments or a mixture of at least one yellow pigment and at least one red pigment;
Colour component R: at least one red pigment, or a mixture of at least two different red pigments, or a mixture of at least one red pigment and at least one yellow pigment.

With this CRYK ink composition, it is possible to provide decors on different carrier materials that are shifted in the colour space towards orange-red.

The use of a mixture or combination of red and yellow pigments for the colour components R and Y in the printing ink according to the disclosure, on the other hand, enables the desired shift in the colour space with an increase in the orange-red colour component. This colour space is adapted for a warmer colour tone or impression, e.g. of wood decorations in analogue printing or gravure printing. It should be noted that analogue printing usually uses at least 5 primary colours, whereas digital printing is limited to 4 primary colours. Thus, with the present ink, it is possible to use this larger colour space in both analogue printing and digital printing without any changes that would lead to undesirable metamerism effects. White primed wood-based panels on the one hand and white primed papers on the other hand can now be used as carrier materials. As long as the same décor is printed on both carrier material using ink sets with the pigments mentioned, metamerism is largely avoided. At the same time, costs are reduced.

In non-limiting embodiments of the ink used herein, the colour component Y is a mixture of two yellow pigments or a mixture of a yellow pigment and a red pigment or a mixture of two yellow pigments and a red pigment.

PY150, 151, 154, 175, 180 or 194 can be used as yellow pigments, whereby PY150 and PY181 are preferred. PY181 and PY151 are benzimidazolone azo pigments, but PY181 has different substituents than PY151. For example, PY181 contains an amidobenzene side chain as R4 substituent, whereas PY151 has only a hydrogen at the same position. PY181 has good acid and base stability as well as solvent stability and is readily dispersible.

In non-limiting embodiments, the colour component Y is a mixture of a first yellow base pigment and up to 30% by weight, preferably up to 20% by weight, of a second yellow pigment, in particular a mixture of PY 150 and 20% by weight of PY181 (% by weight are in each case based on the colour component Y).

In non-limiting embodiments, the colour component Y is a mixture of a first yellow base pigment and up to 10% by weight, preferably up to 5% by weight, of a red pigment, in particular from the group of quinacridone pigments, in particular a mixture of PY150 and 5% by weight of PR 207 (% by weight are in each case based on the colour component Y).

The red quinacridone pigment belongs to a group of organic pigments derived from the basic structure of quinacridone. They exhibit very good weather fastness, high colour strength and high chemical resistance. The red pigment used is preferably selected from the group containing 2,9-dimethylquinacridone (pigment red 122), 2,9-dichloroquinacridone (pigment red 202), mixed crystal of quinacridone and 4, 11-dichloroquinacridone (pigment red 207) and 3,10-dichloroquinacridone (pigment red 209). The red pigment PR207 as a solid solution of quinacridone and 4, 11-dichloroquinacridone is particularly preferred. A solid solution is to be understood as a solid solution which differs from a purely physical mixture of the individual components. In a solid solution, for example, the molecules of one component are incorporated into the crystal lattice of the other component. PR207 is described with a yellowish-red colour.

In non-limiting embodiments of the ink used herein, the colour component Y is a mixture of a first yellow base pigment, up to 20% by weight, preferably up to 15% by weight, of a second yellow pigment and up to 10% by weight, preferably up to 5% by weight, of a red pigment, in particular from the group of quinacridone pigments, in particular a mixture of PY150, 15% by weight PY181 and 5% by weight PR207 (% by weight are in each case based on the colour component Y).

In non-limiting embodiments of the ink used herein, the colour component R is a mixture of two red pigments or a mixture of one red pigment and one yellow pigment or a mixture of two red pigments and one yellow pigment.

Thus, in one variant, it can be provided that the colour component R is a mixture of a first red base pigment and up to 60% by weight, preferably up to 50% by weight, of a second red pigment, in particular from the group of quinacridone pigments, in particular a mixture of PR254 and 50% by weight of PR207 (% by weight are in each case based on the colour component R).

The red pigment PR254 belongs to the class of diketopyrrolopyrrole pigments and is described with a yellowish-red colour. PR254 is preferably used in automotive paints. However, other red pigments can also be used instead of PR254, such as PR266, 122, 202, 207.

In non-limiting embodiments of the digital printing ink used here, the colour component R is a mixture of a mixture of a red pigment, in particular from the group of quinacridone pigments, and a yellow pigment, in particular a mixture of PR207 and PY181. The amount of PY181 is 5-15 wt %, preferably 6-10 wt % (wt % are in each case based on the colour component R).

In non-limiting embodiments of the digital printing ink used in the present case, the colour component R is a mixture of a first red base pigment, up to 60%, preferably up to 50% of a second red pigment, in particular from the group of quinacridone pigments, and a yellow pigment, in particular a mixture of PR254, 50% by weight PR207 and PY181. The amount of PR207 is about 50 wt % and the amount of PY181 is 3-10 wt %, preferably 3-5 wt % (wt % are in each case based on the colour component R).

The present CRYK digital printing ink can be used in the following combinations of colour component R and Y, wherein at least one cyan pigment is present as colour component C and at least one black carbon pigment is present as colour component K, respectively:
a) Colour component Y: mixture of two yellow pigments; colour component R: one red pigment;
b) Colour component Y: Mixture of a yellow pigment and a red pigment, in particular from the group of quinacridone pigments; colour component R: a red pigment;
c) Colour component Y: Mixture of two yellow pigments and one red pigment, in particular from the group of quinacridone pigments; colour component R: one red pigment;
d) colour component Y: a yellow pigment; colour component R: mixture of two red pigments, one of the red pigments preferably being from the group of quinacridone pigments;
e) Colour component Y: Mixture of two yellow pigments; Colour component R: Mixture of two red pigments, wherein one of the red pigments is preferably from the group of quinacridone pigments;
f) Colour component Y: Mixture of a yellow pigment and a red pigment, in particular from the group of quinacridone pigments; colour component R: Mixture of two red pigments, one of the red pigments preferably being from the group of quinacridone pigments;
g) Colour component Y: Mixture of two yellow pigments and one red pigment, in particular from the group of quinacridone pigments; colour component R: Mixture of two red pigments, one of the red pigments preferably being from the group of quinacridone pigments;
h) colour component Y: a yellow pigment; colour component R: mixture of two red pigments, one of the red pigments preferably being from the group of quinacridone pigments, and a yellow pigment.
i) colour component Y: mixture of two yellow pigments; colour component R: mixture of two red pigments, one of the red pigments preferably being from the group of quinacridone pigments, and a yellow pigment
j) Colour component Y: mixture of a yellow pigment and a red pigment, in particular from the group of quinacridone pigments; colour component R: mixture of two red pigments, one of the red pigments preferably being from the group of quinacridone pigments, and a yellow pigment.
k) Colour component Y: Mixture of two yellow pigments and one red pigment, in particular from the group of quinacridone pigments; colour component R: Mixture of two red pigments, one of the red pigments preferably being from the group of quinacridone pigments, and one yellow pigment.

It should be noted that the different colour pigments for colour component R and colour component Y are respectively combined or mixed before application.

In non-limiting embodiments of the ink used in the present method, the at least one cyan pigment is a copper phthalocyanine pigment, preferably C.I. Pigment Blue (PB) 15:3 or C.I. Pigment Blue 15:4, more preferably C.I. Pigment Blue 15:3.

In non-limiting embodiments of the ink used in the present process, the black carbon pigment is a carbon black pigment, in particular selected from the group consisting of Regal™ 400R, Mogul™, L, Elftex™ 320 from Cabot Co, or Carbon Black FW18, Special Black™ 250, Special Black™ 350, Special Black™ 550, Printex™ 25, Printex™ 35, Printex™ 55, Printex™ 90, Printex™ 150T from DEGUSSA Co., MA8 from MITSUBISHI CHEMICAL Co., and C.I. Pigment Black (PBL) 7 and C.I. Pigment Black 11.

The total pigment concentration in the ink used in the present case is more than 8% by weight, preferably between 6 and 15% by weight, in particular preferably between 4 and 10% by weight, based on the total weight of the ink. The total pigment concentration does not change significantly during mixing-only the proportion of the individual pigments is changed during mixing.

As already mentioned, the ink used in the present case is an aqueous ink. The water content in the ink is at least 50%, preferably above 50%, in particular preferably at least 55%, e.g. 51%, 52% or 53%.

The ink used in the present case also has a solvent content. Thus, the ink contains at least one organic solvent with a proportion of less than 45%, preferably less than 43%; e.g. 41%, 42%.

The organic solvent keeps the ink in a processable consistency, especially in combination with further additives such as dispersing aids. Glycol or other alcohols such as ethanol can be used as organic solvents.

In addition, the ink used in the present case may contain further additives such as biocides, humectants, acid/bases for adjusting the pH value, surfactants as surface-active substances. The humectants may include 2-pyrrolidone, glycerol and 1,2-hexanediol in an amount between 0.1 and 25% by weight, based on the total weight of the aqueous inkjet ink.

As mentioned above, the present process can be used to print on various carrier materials, such as paper layers or wood-based panels.

Thus, in non-limiting embodiments, the at least one carrier material to be printed is at least one base paper. In this context, base papers are understood to be papers that have neither been subjected to sizing in the mass nor impregnation of the surface with a resin or glue. Base papers essentially consist of cellulose, pigments and fillers and the usual additives. For the production of base papers such as decor papers, softwood pulps, hardwood pulps or mixtures of both types of pulp can be used. Inorganic colour pigments such as metal oxides, metal hydroxides and metal oxide hydrates, metal sulphides, metal sulphates, metal chromates and metal molybdates as well as organic colour pigments and/or dyes such as carbonyl colourants, cyanine colourants and others can be used to colour the base papers.

In non-limiting embodiments, the base paper to be printed is at least one paper web without impregnation with at least one ink-receiving layer. The ink-receiving layer is preferably a hydrophilic coating containing water-soluble or water-dispersible polymers or binders and inorganic pigments.

For example, polyvinyl alcohol, polyvinyl pyrrolidone, polyvinyl acetate, starch, gelatin, carboxymethyl cellulose, ethylene/vinyl acetate, styrene/acrylic acid ester copolymers or mixtures thereof may be used as binders.

Inorganic white pigments such as silicates, kaolin, calcium carbonate, aluminium hydroxide, talc, titanium dioxide or colour pigments such as iron oxide, carbon black or organic colour pigments can be contained as inorganic pigments in the ink-receiving layer. The ratio of pigment to binder in the ink-receptive layer is between 1:0.05-1:1 based on the solids content.

In non-limiting embodiments, the ink-receiving layer contains silicates, aluminium oxides, aluminium hydroxides or aluminium silicates and polyvinyl alcohol as a water-soluble polymeric binder.

The basis weight of the ink-receptive layer can be between 0.5-20 g/m².

In non-limiting embodiments, the at least one carrier material to be printed is at least one pre-treated, impregnated paper. By a pre-treated paper (or cellulose layer) is meant a paper or paper web impregnated with a resin solution. The paper can be impregnated with a wide variety of resin solutions, for example melamine resins and urea resins, plastic-acrylate compounds or starch-glue. Mixtures of the resins may also be present. It is also possible to impregnate the paper using resin powder. The use of resin powder is described in detail below.

In non-limiting embodiments, an impregnated paper is used which is prepared by the following process steps (see also EP 2 980 313 A1): a) complete impregnation of the cellulose layer with a curable resin, e.g. melamine-formaldehyde resin), b) removing the excess resin that forms on the surface (e.g. by peeling or scraping off), c) drying the impregnated cellulose layer in such a way that, after evaporation of the water from the resin, the cellulose fibres on the surface from which the resin has been removed are at least partially exposed.

Peeling or doctoring causes the resin remaining on the surface of the cellulose layer to seal with the fibre tips. In the drying process, the resin retracts into the fibres so that the fibres are impregnated with the resin but not enclosed by it. Such a surface is suitable for printing with aqueous digital inks.

The special equipment used for doctoring works similar to a spatula machine where one or more rollers run backwards on the paper and pick up the excess resin. By varying the speed of the rollers, the amount can be precisely controlled and repeatability ensured.

To improve the printing result, the treated paper (base paper without or with ink-receptive layer, impregnated paper) can additionally be provided with a primer material.

The primer material can be a water-based synthetic resin or acrylic resin dispersion that is completely miscible with water or partially soluble in water. The primer material should have a low solvent content of less than 3%.

As indicated above, the print decoration is applied to the carrier material in direct printing by means of a digital printing process using the CRYK ink described above. In digital printing, the printed image is transferred directly from a computer to a printing machine, such as an inkjet printer. The decor data is translated into machine data by software (e.g. RIP software from the manufacturer Colorgate).

The printed papers (base paper or impregnated paper) can be provided with a resin layer as a protective layer after printing. This protective layer can consist of a not yet fully cured resin, preferably a formaldehyde-containing resin, in particular preferably melamine-formaldehyde resin, urea-formaldehyde resin and/or melamine-urea-formaldehyde resin. This protective layer serves to protect the printing decorations and enables intermediate storage.

As mentioned, the applied protective layer should not yet be fully cured, which is controlled in particular by the drying process.

In particular, all impregnated papers must have a residual moisture content, regardless of the intended use. This enables the creation of qualitatively flawless products regardless of the type of further processing (short-cycle, Conti or multi-daylight press). The residual moisture is an indication of the degree of cross-linking of the synthetic resins used.

The resins used for impregnating paper layers (or also for direct coating of other carrier plates, see below) pass through various polymerisation and cross-linking states in these processes.

This is illustrated below using the example of melamine-formaldehyde resin, which is frequently used in the manufacture of wood-based panels.

Melamine and formaldehyde first react to form methylol groups on the amino groups of melamine to form water-soluble products (see Scheme I).

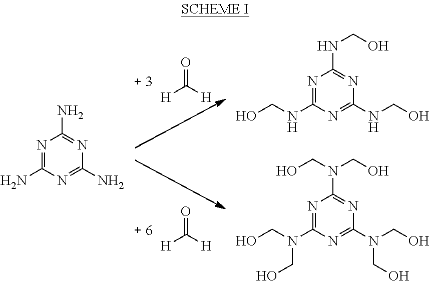

These melamine-formaldehyde monomers undergo polycondensation after the addition of a suitable catalyst, preferably an acid, resulting in the linking of the monomers via ether and methylene groups and the formation of higher molecular weight precondensates and polycondensates (see Scheme II).

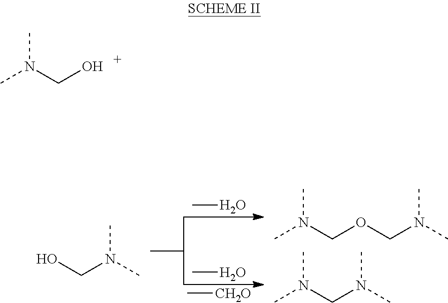

Precondensates and polycondensates differ in terms of their molar mass and solubility. Thus, the low-molecular-weight precondensates can still have limited solubility in water, while the higher-molecular-weight polycondensates are insoluble. The limited water solubility of the precondensates is due, among other things, to the still free methylol groups and the low degree of cross-linking of the mostly still linear oligomers. The precondensates are thus a polymerisation intermediate.

When the polycondensates are completely cured, strong cross-linking occurs with the splitting off of the methylol groups still present, whereby closely meshed cross-linked plastics are formed via methylene groups (see Scheme III).

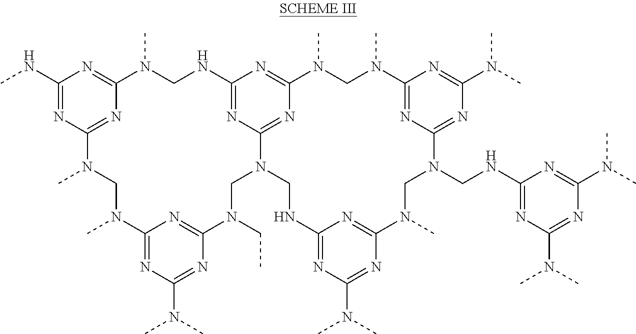

For synthetic resins curing via condensation reactions, a distinction is therefore made between the following resin states:
A-state: easily soluble in solvents, meltable, curable;
B-state: only partially soluble in solvent, meltable, hardenable;
C-State: insoluble, cured

In the case of using impregnated paper layers for finishing wood-based panels, e.g. for high-quality flooring panels, it is desirable that the impregnating resin is not yet fully cured, but is preferably still in the partially cross-linked B-state. During further processing in the press, this still enables flowing/filming in combination with further cross-linking of the synthetic resins. Accordingly, the present impregnated and printed papers are preferably dried to the B state.

The printed and, if necessary, coated or impregnated paper can then be pressed with a material plate, at least one protective paper (overlay) and, if necessary, a backing paper.

In non-limiting embodiments, the at least one carrier material to be printed is at least one material board, in particular a wood material board, such as MDF and HDF boards made of wood fibres, particle boards made of chips, OSB made of wood strands, wherein the wood fibres, wood chips and wood strands are each mixed with suitable adhesives and hot pressed), WPC boards, plastic board, e.g. SPC (stone plastic composite) or a cement fibre board. Suitable for direct printing are e.g. carrier materials such as wood materials, wood material-plastic mixtures, WPC, plastics or mixtures of different plastics, for example PE, PP, PVC, PU, all also with fillers such as chalk, talc or also fibres.

In non-limiting embodiments, the surface of the material board can be pre-treated before printing to improve the adhesion of the subsequent layers. This can be a cleaning with brushes, a sanding, which also frees the surface from unevenness, and/or a plasma or corona treatment.

In non-limiting embodiments, an unsanded wood-based board, in particular MDF or HDF, can also be used, which is still provided with a pressed skin (rotting layer) on the upper side. Water-based melamine resin is applied to the top side to fill the press skin. The melamine resin is later melted in the short-cycle press and thus has a tempering effect in the area of this layer; i.e. it counteracts delamination.

In non-limiting embodiments, at least one base coat is applied in a next step to increase the opacity.

The base coat preferably comprises casein, corn starch or soy protein and may contain inorganic colour pigments and thus serve as a base coat layer for the decorative layer to be subsequently printed on.

White pigments such as titanium dioxide TiO₂ can be used as colour pigments. Other colour pigments can be calcium carbonate, barium sulphate or barium carbonate, but also iron oxide pigments (for a brownish base coat). In addition to the colour pigments and the casein, corn starch or soy protein, the base coat can also contain water as a solvent.

The amount of liquid base coat applied may be between 10 and 50 g/m², preferably between 15 and 30 g/m², more preferably between 20 and 25 g/m.²

It is also conceivable that the base coat consists of at least one, preferably at least two or more successively applied layers or applications (e.g. up to five applications), wherein the application quantity between the layers or applications is the same or different, i.e. the application quantity of each individual layer may vary.

The base coat can be applied to the material board using a roller with subsequent drying. It is also possible to apply the base coat to the material board using digital printing. In this case, water-based inks enriched with white colour pigments are preferably used, which are suitable for the digital printing inks used below. Application by means of digital printing is advantageous because the printing equipment is significantly shorter than a rolling device and thus saves space, energy and costs.

In non-limiting embodiments of the present method, a primer layer is applied to the base coat, preferably as a single application with subsequent drying. The amount of liquid primer applied is between 10 and 30 g/m², preferably between 15 and 20 g/m². Polyurethane-based compounds are preferably used as primers.

Following the printing of the primed material board in digital printing using the CMYK or CRYK ink described above, the decorative layer can also be provided with a protective coating (as already described above for the papers).

This protective layer can be a formaldehyde-containing resin (in the B-state, see above), in particular a melamine-formaldehyde resin, urea-formaldehyde resin or melamine-urea-formaldehyde resin, or a mixture of the resins and glass beads (size 50-150 μm) as spacers for optional intermediate storage of the panels. This protective layer serves as a temporary protection of the decorative layer for storage before further finishing. The protective layer on the decorative layer is not yet fully cured, but has a certain residual moisture of about 10%, preferably about 6%, and can still be further cross-linked. In case of intermediate storage, the resin thus remains in state B (not yet fully cured and cross-linked), whereby the decor is protected. The glass beads can be added to the resin or sprinkled on top and act as spacers. Such protective layers are described, for example, in WO 2010/112125 A1 or EP 2 774 770 B1.

Alternatively, go directly to the next processing step.

In a more advanced non-limiting embodiment, at least one wear protection layer is applied to the printed material board (with or without a protective layer).

This wear protection layer can consist of one or more layers, e.g. three, four, five or six layers.

The drying of the resin layers takes place at dryer temperatures between 15° and 220° C., preferably between 18° and 210° C., in particular in a convection dryer.

In the pressing step following the (final) drying step, the layer structure is pressed under the influence of pressure and temperature in a short-cycle press at temperatures between 15° and 250° C., preferably between 18° and 230° C., more preferably at 200° C., and at a pressure between 30 and 60 kg/cm², more preferably between 40 and 50 kg/cm². The pressing time is between 5 to 15 sec, preferably between 7 to 10 sec. In comparison: for decor papers, a pressure of 50-60 kg/cm² is applied for 16 sec.

Preferably, the coated material board is aligned in the short-cycle press with a structured press plate located in the short-cycle press by means of markings on the wood-based material board, so that congruence is produced between the decor on the wood-based material board and the structure of the press plate to be imprinted. This enables the production of a decor-synchronous structure. During pressing, the melamine resin layers melt and form a laminate through a condensation reaction involving the corundum/glass/fibre components.

### Example 1

With the help of a digital printer, a wood decor (D4727, grey ash) was printed as a master template. Then, with the help of the software, specific colour deviations were created (95% and 87%), whereby the reddish hue was less and less pronounced. These colour deviations were measured together with the master template using an NIR measuring head. The NIR measuring head was always positioned at an identical point in the print.

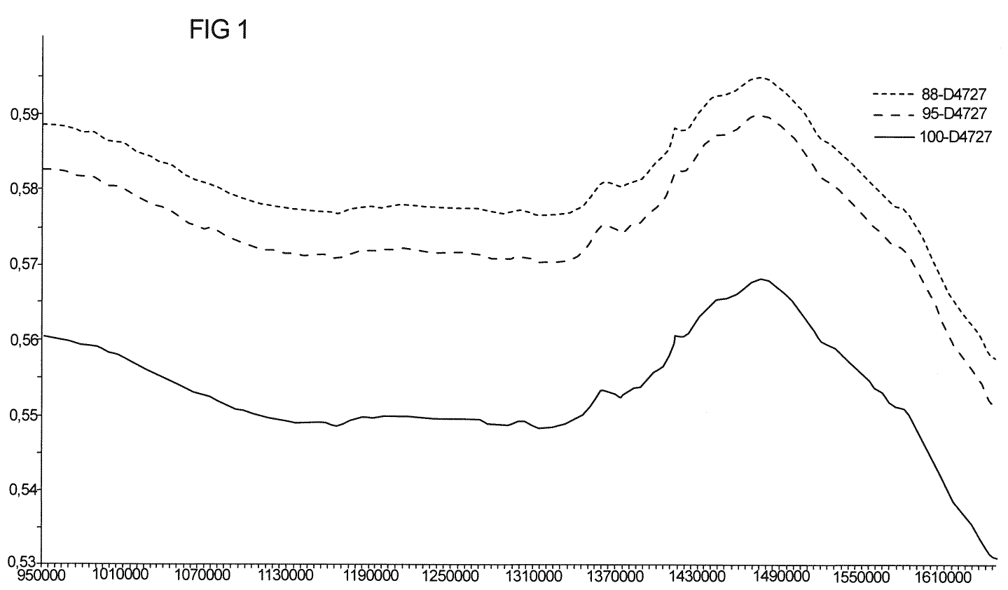

As can be seen in the diagram in FIG. 1, there is a clear gap between the master template (100%) and the two samples with the colour deviations. While the sample with the designation 95-D4727 is still acceptable, a clear deviation can be seen for the sample with the designation 87-D4727 in the test cabin under standard light (e.g. standard illuminant D65 according to ISO 3668, ASTM 1729 as well as DIN 6173-2).

### Example 2

A wood decor (D4727, grey ash) was printed continuously as a master template on a digital printer. A measuring head was positioned at a fixed point above the print. This measuring head continuously recorded NIR spectra of the decor (master template). An average spectrum was then calculated from these individual spectra. Then, with the help of the software, a colour deviation was deliberately created on this decor, whereby the reddish hue became less and less pronounced. NIR spectra were again recorded during the production of these “colour deviations” at the same point on the digital printer. An average spectrum was calculated from the individual spectra and compared with the average spectrum of the master template.

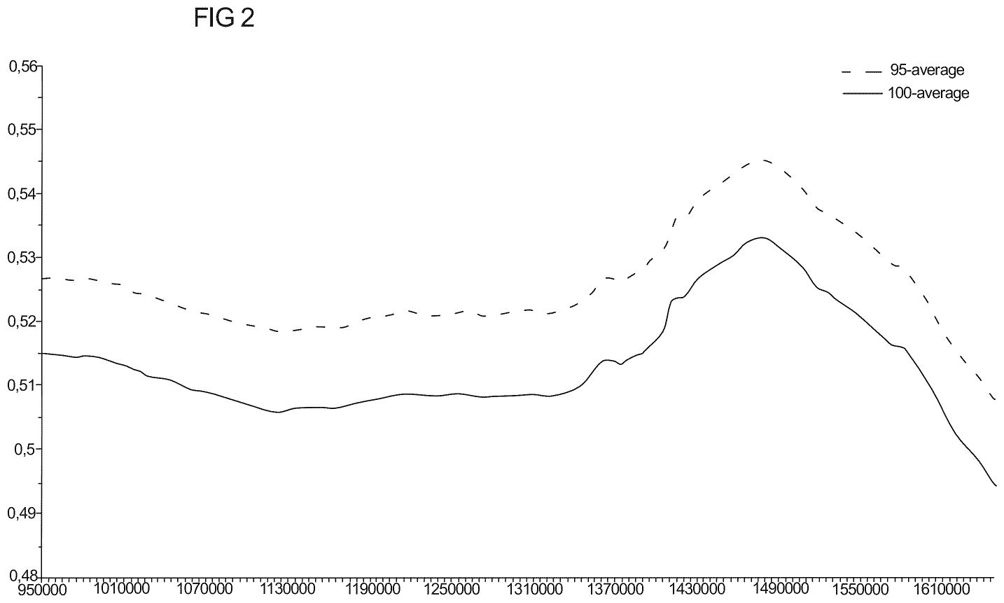

As can be seen from the diagram in FIG. 2, continuous quality control on a printing press is possible with the aid of an NIR measuring head.

As already mentioned, this process can be used in indirect gravure printing as well as in digital printing. Of course, a different carrier material, such as wood-based panels, foils, pre-impregnates, etc., can also be used. The only prerequisite is that the inks used are based on organic molecules.

A range for colour deviations can be specifically defined for each décor during development, or colour deviations can be detected during initial production and assessed in terms of their visibility.

1. A method for determining the colour deviation of at least one print decoration applied to at least one carrier material from a print template using only NIR spectroscopy,
comprising the steps of:
recording of at least one NIR spectrum of several reference samples with the print template using at least one NIR measuring head in a wavelength range between 700 nm and 2500,
applying the at least one printed decoration to the at least one carrier material by means of printing,
recording at least one NIR spectrum of the carrier material printed with the print decoration using the at least one NIR measuring head in a wavelength range between 700 nm and 2500 nm, and
determining the colour deviation of the print decor by comparing with the at least one NIR spectrum recorded for the print template.

2. The method according to claim 1, wherein spectral data from the entire recorded spectral range are used to determine the color deviation.

3. The method according to claim 1, wherein spectral data from the NIR spectral range between 1350 nm and 1600 nm are used to determine the colour deviation.

4. The method according to claim 1, wherein the determination of the colour deviation is carried out continuously and online or offline.

5. The method according to claim 1, wherein the at least one carrier material comprises at least one paper layer.

6. The method according to claim 1, wherein the at least one carrier material is a board made of a wood material, made of plastic, a wood material-plastic mixture, a composite material, a cement fibreboard, gypsum fibreboard, a WPC board (Wood Plastic Composites), or an SPC board (Stone Plastic Composites).

7. The method according to claim 1, wherein the printed decoration is applied to the at least one carrier material by gravure printing processes or digital printing processes.

8. The method according to claim 1, wherein the ink used for printing is a water-soluble CMYK ink.

9. The method according to claim 1, wherein the ink used for printing is a water-soluble CRYK ink having the following composition:
Colour component C: at least one cyan pigment;
Colour component K: at least one black carbon pigment;
Colour component Y: at least one yellow pigment; or a mixture of at least two different yellow pigments or a mixture of at least one yellow pigment and at least one red pigment;
Colour component R: at least one red pigment, or a mixture of at least two different red pigments, or a mixture of at least one red pigment and at least one yellow pigment.

10. The method according to claim 9, wherein the colour component Y is a mixture of two yellow pigments or a mixture of a yellow pigment and a red pigment or a mixture of two yellow pigments and a red pigment.

11. The method according to claim 9, wherein the colour component R is a mixture of two red pigments or a mixture of a red pigment and a yellow pigment or mixture of two red pigments and a yellow pigment.

12. The method according to claim 9, wherein the at least one cyan pigment is a copper phthalocyanine pigment.

13. The method according to claim 9, wherein the black carbon pigment is a carbon black pigment.

14. The method according to claim 9, wherein the water content in the ink is at least 50%.

15. The method according to claim 9, wherein the ink contains at least one organic solvent at a level of less than 45%.

16. The method according to claim 1, wherein the at least one NIR measuring head is used in a wavelength range between 900 nm and 1800 nm.

17. The method according to claim 1, wherein the at least one NIR measuring head is used in a wavelength range between 900 nm and 1800 nm.

18. The method according to claim 5, wherein the at least one paper layer is at least one base paper or at least one pre-treated, impregnated paper.

19. The method according to claim 6, wherein the board made of the wood material is a chipboard, medium-density fibreboard (MDF), high-density fibreboard (HDF), oriented strand board (OSB) or plywood board.

20. The method according to claim 9, wherein the water content in the ink is at least 55%.
